(19) United States
(12) Patent Application Publication
(10) Pub. No.: US 2017/0071391 A1
(43) Pub. Date: Mar. 16, 2017

(54) APPARATUS AND METHOD FOR BATCH COOKING IN CONTINUOUS AUTOMATED PLANT

(71) Applicant: CUISINE SOLUTIONS, INC., Sterling, VA (US)

(72) Inventor: Jean-Pierre GUILLAUD, Alexandria, VA (US)

(73) Assignee: CUISINE SOLUTIONS, INC., Sterling, VA (US)

(21) Appl. No.: 15/122,711

(22) PCT Filed: Mar. 3, 2015
(86) PCT No.: PCT/US2015/018413

§ 371 Date: Aug. 31, 2016

Related U.S. Application Data
(60) Provisional application No. 61/947,717, filed on Mar. 4, 2014.

(51) Int. Cl. A47J 27/00; B65G 19/02; A23L 5/10; B65G 59/06; B65G 60/00; B65G 47/96; B65G 15/00; B65G 57/30

(52) U.S. Cl. CPC A47J 27/002; B65G 15/00; B65G 19/02; B65G 57/303; B65G 59/063; B65G 60/00; B65G 47/962; A23L 5/10; A23V 2002/00

(57) ABSTRACT

An apparatus and method involves continuously conveying a plurality of solid food products to a plurality of loading stations where the solid food products can be loaded onto racks, each station including an apparatus for stacking a plurality of the loaded racks into a batch. The apparatus further includes a plurality of cookers capable of simultaneously cooking the solid food products provided on the loaded, stacked racks as a batch, and a batch conveyor for conveying the plurality of loaded, stacked racks as a batch to one of a plurality of cookers, where the solid food products in the batch are cooked under the same conditions. The apparatus also includes an unloading station to which a plurality of loaded, stacked racks are conveyed as a batch by the batch conveyor after the solid food products provided thereon have been cooked in one of the plurality of cookers.

### TECHNICAL FIELD

The present application relates to an apparatus and method for batch cooking in a continuous automated plant.

### BACKGROUND DISCUSSION

In known continuous automated food processing plants for cooking solid food product, the food is typically squeezed while being pushed from behind as it travels through a cooking section of a particular length. It can be difficult and time consuming to adapt such a plant for different recipes and different food products. It would therefore be advantageous to provide for batch cooking in a continuous automated plant which allows for increased adaptability while retaining a high output quantity.

### SUMMARY

A method of continuous automated batch cooking of food product includes continuously conveying uncooked food product to a loading station for loading the uncooked food product onto a rack using an uncooked food product conveyor, stacking a plurality of the racks loaded with uncooked food product into a stack of racks loaded with uncooked food product at a stacking station using a stack handling mechanism, conveying the stack of racks loaded with uncooked food product from the stacking station to a cooker using the stack handling mechanism, cooking the uncooked food product loaded on the stack of racks using the cooker, conveying the stack of racks loaded with cooked food product to an unstacking station using the stack handling mechanism, successively unstacking the stack of racks loaded with cooked food product at the unstacking station using the stack handling mechanism, successively conveying the unstacked racks loaded with cooked food product from the unstacking station to an unloading station using a rack conveyor, successively unloading the cooked food from the racks loaded with cooked food product at the unloading station using an unloading mechanism, and successively conveying the unloaded racks from the unloading station to the loading station using the rack conveyor.

A method of processing opposite sides of solid food product includes a first conveying step of conveying the solid food product through first processing equipment to process a first side of the solid food product, and a second conveying step of conveying the solid food product through second processing equipment to process a second side of the solid food product opposite the first side. After conveying the solid food product through the first processing equipment and prior to conveying the solid food product through the second processing equipment, the solid food product is conveyed in an inclined direction of travel which is different from a direction of travel through which the solid food product is conveyed through the first processing equipment and a direction of travel through which the solid food product is conveyed through the second processing equipment. When the solid food product is conveyed in the inclined direction of travel, the solid food product is lifted and then drops. Conveying speeds of the first and second conveying steps, an incline angle of inclined direction, and a vertical distance which the solid food product drops are selected such that the solid food product flips over as it drops.

An apparatus for continuous automated batch cooking of food product includes an uncooked food product conveyor which continuously conveys uncooked food product to a loading station for loading the food product onto successive racks, a cooker for cooking uncooked food product loaded on a stack of the racks, a stack handling mechanism for stacking a plurality of the racks loaded with uncooked food product into a stack of racks loaded with uncooked food product at a stacking station, conveying the stack of racks loaded with uncooked food product from the stacking station to the cooker, conveying the stack of racks loaded with cooked food product to an unstacking station, and successively unstacking the stack of racks loaded with cooked food product at the unstacking station, a rack conveyor for successively conveying the unstacked racks loaded with cooked food product from the unstacking station to an unloading station, and successively conveying the unloaded racks from the unloading station to the loading station, and an unloading mechanism provided at the unloading station for successively unloading the cooked food from the racks loaded with cooked food.

### BRIEF DESCRIPTION OF DRAWING

FIG. 1 is a schematic layout view of a batch cooking section of an apparatus for continuous automated batch cooking of food product.

FIGS. 2A and 2B are an underside view of the stack handling mechanism of FIG. 1 in relation to a stack of rack. FIG. 2A shows the support of the mechanism in an unengaged position and FIG. 2B shows the support rotated to an engaged position engaged with the underside of a rack.

FIG. 3 is a schematic overhead view of a continuous pretreating section of the apparatus.

FIG. 4 is a schematic of the apparatus controller.

### DETAILED DESCRIPTION

Hereinafter, exemplary embodiments will be described with reference to the drawing. Dimensional ratios of the drawing are magnified and may be different from actual ratios, for convenience of description.

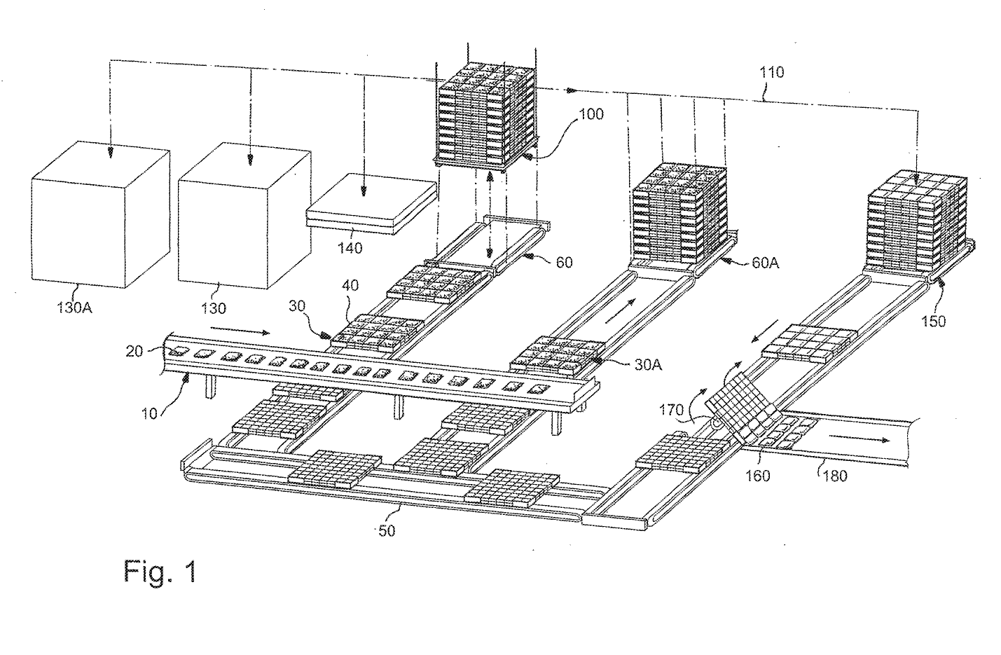

FIG. 1-3 illustrate an apparatus for continuous automated batch cooking of food product. As illustrated in FIG. 1, an uncooked food product conveyor 10 is configured to continuously convey uncooked food product 20 to a loading station 30 for loading the food product onto successive racks 40. In the embodiment, the uncooked food product conveyor 10 is one or more conveyor belts.

The uncooked food product can be, for example, sliced, vacuum packed beef or chicken and can be manually picked up from the conveyor 10 and arranged manually on the rack 40 at the loading station 30 by a worker. As will be discussed further below, empty racks 40 are conveyed to the loading station 30 as needed by, for an example, a worker actuating a rack conveyor 50 to convey the rack 40 to the loading station 30. In the embodiment, the rack conveyor 50 is a plurality of overlapping chain conveyors which can feed the racks 40 among the overlapping chain conveyors. In this embodiment, the loading station 30 comprises one end of a chain conveyor which can feed racks 40 to a stacking station 60 which is described in detail below. Also, in this embodiment, a chain conveyor which extends under the food product conveyor 20 conveys the empty rack to the loading station 30. After a rack 40 is fully loaded with uncooked food product at the loading station 30, the rack 40 is conveyed toward the stacking station 60 by the rack conveyor 50. In the embodiment, a worker actuates the rack conveyor 50 (i.e., the appropriate chain conveyor) to convey the rack 40 towards the stacking station 60. In the embodiment, the stacking station 60 comprising a chain conveyor of the rack conveyor 50 which overlaps with the chain conveyor having the loading station 30 at one end.

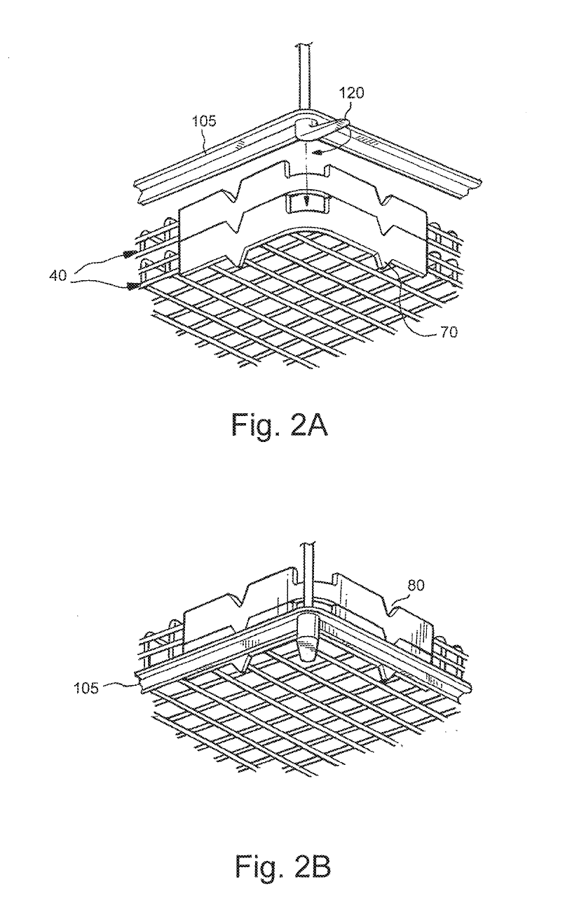

As illustrated in FIGS. 2A and 2B, the racks 40 are vertically stackable. In the embodiment, the stacks are stabilized by legs 70 at the underside of each rack 40 nests within leg cutouts 80 at the top of each rack 40. There are also stacking cutouts 90 at the top of each rack for allowing the racks to be stacked by a stack handling mechanism 100. As illustrated in FIG. 1, the stack handling mechanism 100 comprises a frame 150 which is movable vertically, for example, by a vertical drive, which is itself mounted to move horizontally along ceiling-mounted tracks so that a stack of racks 40 can be moved, by the stack handling mechanism, horizontally along horizontal path 110 and raised or lowered at any point along the horizontal path 110.

As illustrated in FIGS. 2A and 2B, the stack handling mechanism has, for each stacking cutout 90 in the racks 40, a movable support 120 mounted to the frame 105 and configured to engage the rack 40 at the underside of the rack opposite each stacking cutout 90 (for example, at the four corners of the underside of the rack 40). In the embodiment, the movable supports 120 are rotatable in and out of such engagement. With this configuration, the stack handling mechanism 100 can pick up any portion of a stack of racks 40 by aligning its movable supports 120 with the underside of the bottom-most rack 40 of the portion of the racks 40 to be lifted and moving the movable supports 120 inwardly (i.e., rotating the movable supports 120 inwardly) to engage with the underside of that rack 40. Also, the legs 70 are spaced such that a rack 40 resting on the portion of the rack conveyor 50 making up the stacking station 60 is positioned such that its portions which engage the movable supports 120 are raised above the stacking station 60 a sufficient distance such that the movable supports 120 can be moved between those portions and the stacking station 60. The stacking mechanism 100 can thus operate in conjunction with the rack conveyor 100 such that the stack is lifted by the stacking mechanism 100, another rack 40 is moved to the stacking station 60 by the rack conveying mechanism 50, and the stack is lowered onto that rack 40 by the stacking mechanism 100 so that it is added to the stack.

After a stack of racks 40 loaded with uncooked food product 20 has reached a desired number of racks, the stack handling mechanism 100 lifts the stack vertically off of the stacking station 60, moves horizontally until it is positioned above a cooker 120, lowers the stack into the cooker 120, moves (i.e., rotates) the movable supports 120 out of engagement with the bottom-most rack 40 in the stack, and then picks up a lid 140 from a lid storage and places the lid 140 on the top of the cooker 120. The lid 140 In the embodiment, the cooker 120 is a heated water bath which cooks the food product using a known sous vide process.

While a food product on a stack of racks 40 is being cooked in a cooker, another stack of racks 40 loaded with uncooked food product 20 can be formed at the loading station 30 and stacking station 60 or at a parallel loading station 30A and stacking station 60A which have the same configuration of the loading station 30 and stacking station 60. That stack of racks 40 loaded with uncooked food product 20 can then be conveyed to parallel cooker 130A so that multiple batches of food product can be cooked simultaneously in separate cookers. Each batch can be of the same type of food product or a different type of food product, with each cooker being set to the appropriate temperature for the type of food being cooked in that batch and the recipe being used.

After food product on a stack of racks within a cooker 130 or 130A has been cooked for the amount of time appropriate to cook the food product, the stack handling mechanism 100 removes the lid 140 and replaces the lid 140 at the lid storage, removes the stack, and conveys the stack to an unstacking station 150 where the stack is set down by the stack handling mechanism 100. The stack handling mechanism successively lifts all but the bottom-most rack 40 of the stack of racks of cooked food product 160, the rack conveyor 50 conveys the bottom-most rack to an unloading station 170, and the process is repeated until all of the racks 40 in the stack are successively conveyed from the unstacking station 150 to the unloading station 170. The stack handling mechanism 100 can thus stack a plurality of the racks 40 loaded with uncooked food product 20 into a stack of racks loaded with uncooked food product at the stacking stations 60 or 60A, convey the stack of racks loaded with uncooked food product from to one of the cookers 130 or 130A, convey the stack of racks loaded with cooked food product to the unstacking station 150 and successively unstack the stack of racks 40 loaded with cooked food product 160 at the unstacking station 150. In the embodiment, the unstacking station 150 comprises one end of one of the chain conveyors that make up the rack conveyor 50.

In the embodiment, the unloading station 170 comprises a member (in the embodiment, a roller rotatably mounted to a rod) which is configured to rotate upward and contact an underside of the rack 40 on one side (in the embodiment, the rod pivots about one end such that the roller mounted at the other end contacts the underside of the rack). The rack 40 is tilted by this upward rotational contact and the cooked food product 160 on the rack is unloaded from (i.e. slides off) of the rack 40 and onto a cooked food conveyor 180, which, in the embodiment, is a conveyor belt. For example, the member rotates upward and then downward when a sensor detects that a rack 40 has been moved to the unloading station 170. The rack conveyor 50 then conveys the unloaded, empty racks to a portion of the rack conveyor 50 at which they are stored until a worker actuates the rack conveyor to convey a rack 40 to one of the loading stations 30 or 30A. In the embodiment, the portion of the rack conveyor 50 at which the racks 40 are stored is perpendicular to the portions of the rack conveyor 50 which convey racks 40 to and from the stations 30, 30A, 60, 60A, 150, and 170. Because the racks 40 are wider than the rack conveyor portions 50, the racks 40 can overlap two perpendicular rack conveyor 50 portions where they intersect and can be fed onto and off of the intersecting perpendicular portions of the rack conveyor 50. Additionally, if more racks are needed, the rack handling mechanism 100 can transport a stack of empty racks provided in a rack storage to the unloading station 170 where they can be unloaded and then fed around by the rack conveyor 50 to the loading station 30 or 30A.

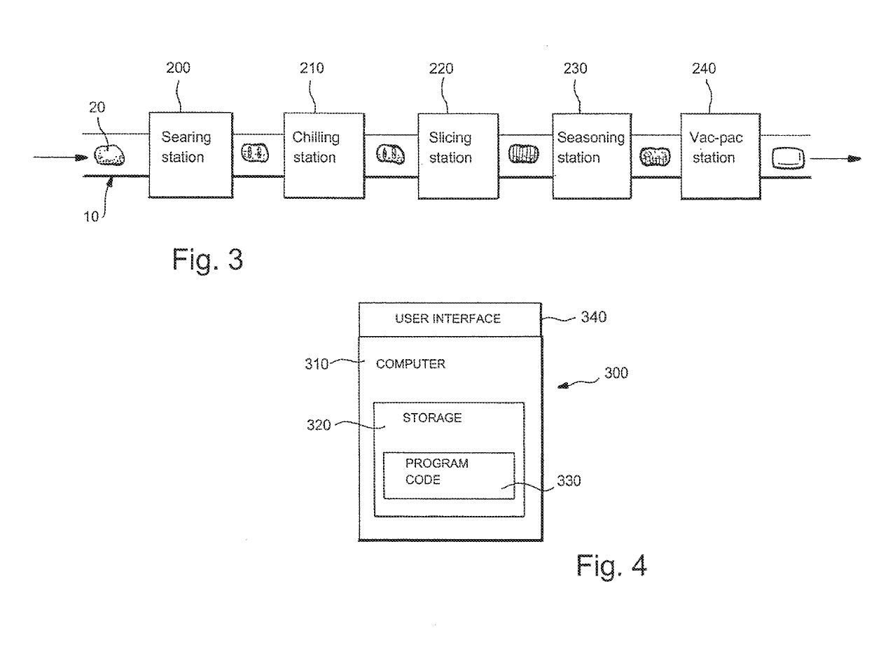

In the embodiment, prior to being loaded onto a rack, the uncooked food product 20 can be pre-treated. For example, as illustrated in FIG. 3, the uncooked food product is sequentially conveyed by the uncooked food product conveyor 10 to a searing station 200 at which grill marks are seared into one or both sides of the food product 20, a chilling station 210 at which the food product is chilled, a slicing station 220 at which the food product is sliced, for example, in a direction against the grain so that the muscle retains its shape, a seasoning station 230 at which the food product is seasoned, and a vacuum-pack station 240 at which the food product is sealed in a vacuum-pack pouch.

In the embodiment, the apparatus is at least partially automated. In particular, while one or more workers may be manning the stations 30, 30A, 200, 210, 220, 230 and/or, 240, the operation of the stack handling mechanism 100 can be fully automated. For example, when a worker actuates the rack conveyor 50 to move a rack from a loading station 30 or 30A to a stacking station 60 or 60A, the actuation signal is also sent to a controller 300, which controls the stack handling mechanism 100 by actuating the vertical drive and the movable supports 120, to add the conveyed rack 40 to the stack. The controller 300 can also count the number of racks 40 that have been added to each stack, and can convey the appropriate stack to the appropriate cooker 130A or 130B when the appropriate number of racks in the stack has been reached. The controller 300 can also count cooking time and control the stack handling mechanism 100 to remove the stack from the cooker 130A or 1306 after the cooking time has passed, convey the stack to the unloading station 150, and unstack the stack in conjunction with the rack conveyor 50 by actuating the various portions of the rack conveyor 50. The controller 300 can also be configured to control actuation of the food product conveyors 10 and 180, the member of the unloading station 170, and the temperature setting of the cookers 130 and 130A. The controller 300 includes, for example, a computer 310 having a program code 330 stored in a storage 320 which is a non-transitory computer readable medium, and is operatively connected to receive signals from the apparatus' various sensors and transmit actuation signals to the portions of the apparatus discussed above. The program code 330 can be configured to allow a user using a user interface 340 connected to the computer 330 to monitor and modify the control of the apparatus.

With the disclosed apparatus, different types of food product can be quickly and efficiently processed. For example, if the recipe is to be revised, the programmed cooking time and temperature and/or number of racks per stack can quickly be revised as needed via the user interface 340.

The detailed description above describes an apparatus and method for batch cooking in a continuous automated plant. The apparatus and method for batch cooking in a continuous automated plant is disclosed by way of example. The invention is not limited, however, to the precise embodiment and variations described. Various changes, modifications and equivalents can be effected by one skilled in the art without departing from the spirit and scope of the invention as defined in the accompanying claims. It is expressly intended that all such changes, modifications and equivalents which fall within the scope of the claims are embraced by the claims.

What is claimed is:

1. A method of continuous automated batch cooking of food product, comprising:
continuously conveying uncooked food product to a loading station for loading the uncooked food product onto a rack using an uncooked food product conveyor;
stacking a plurality of the racks loaded with uncooked food product into a stack of racks loaded with uncooked food product at a stacking station using a stack handling mechanism;
conveying the stack of racks loaded with uncooked food product from the stacking station to a cooker using the stack handling mechanism;
cooking the uncooked food product loaded on the stack of racks using the cooker;
conveying the stack of racks loaded with cooked food product to an unstacking station using the stack handling mechanism;
successively unstacking the stack of racks loaded with cooked food product at the unstacking station using the stack handling mechanism;
successively conveying the unstacked racks loaded with cooked food product from the unstacking station to an unloading station using a rack conveyor;
successively unloading the cooked food from the racks loaded with cooked food product at the unloading station using an unloading mechanism; and
successively conveying the unloaded racks from the unloading station to the loading station using the rack conveyor.

2. The method of claim 1, wherein the uncooked food product is conveyed to one or more pretreating stations for pretreating the uncooked food product and then to the loading station by the food product conveyor.

3. The method of claim 2, wherein the one or more pretreating stations comprise one or more of a searing station, a chilling station, a slicing station, a seasoning station, or a vacuum-pack station.

4. The method of claim 1, wherein the stack handling mechanism comprises a vertically movable frame and a plurality of movable supports mounted to the frame for supporting an underside of the plurality of racks.

5. The method of claim 1, wherein a plurality of cookers are provided and food product on a plurality of stacks of racks are simultaneously cooked in the plurality of cookers.

6. The method of claim 1, wherein the stack handling mechanism moves a lid from a lid storage to the top of the cooker at a start of the cooking of food on the stack of racks in the cooker.

7. The method of claim 1, wherein the unloading mechanism comprises a member which is configured to contact an underside of the rack at the loading station and tilt the rack to one side to unload the cooked food product on the rack onto a cooked food conveyor.

8. The method of claim 1, wherein a second plurality of uncooked food product is conveyed by the uncooked food product conveyor to a second loading station adjacent a second stacking station.

9. An apparatus for continuous automated batch cooking of food product, comprising:
an uncooked food product conveyor which continuously conveys uncooked food product to a loading station for loading the food product onto successive racks;
a cooker for cooking uncooked food product loaded on a stack of the racks;
a stack handling mechanism for stacking a plurality of the racks loaded with uncooked food product into a stack of racks loaded with uncooked food product at a stacking station, conveying the stack of racks loaded with uncooked food product from the stacking station to the cooker, conveying the stack of racks loaded with cooked food product to an unstacking station, and successively unstacking the stack of racks loaded with cooked food product at the unstacking station;
a rack conveyor for successively conveying the unstacked racks loaded with cooked food product from the unstacking station to an unloading station, and successively conveying the unloaded racks from the unloading station to the loading station; and
an unloading mechanism provided at the unloading station for successively unloading the cooked food from the racks loaded with cooked food.

10. The apparatus of claim 9, wherein the food product conveyor conveys the uncooked food product to one or more pretreating stations for pretreating the uncooked food product and then to the loading station.

11. The apparatus of claim 10, wherein the one or more pretreating stations comprise one or more of a searing station, a chilling station, a slicing station, a seasoning station, or a vacuum-pack station.

12. The apparatus of claim 9, wherein the stack handling mechanism comprises a vertically movable frame and a plurality of movable supports mounted to the frame for supporting an underside of the plurality of racks.

13. The apparatus of claim 9, wherein a plurality of cookers are provided and food product on a plurality of stacks of racks are simultaneously cooked in the plurality of cookers.

14. The apparatus of claim 9, wherein the stack handling mechanism moves a lid from a lid storage to the top of the cooker at a start of the cooking of food on the stack of racks in the cooker.

15. The apparatus of claim 9, wherein the unloading mechanism comprises a member which is configured to contact an underside of the rack at the loading station and tilt the rack to one side to unload the cooked food product on the rack onto a cooked food conveyor.

16. The apparatus of claim 9, wherein the uncooked food product conveyor conveys a second plurality of uncooked food product to a second loading station adjacent a second stacking station.
